(19) United States
(12) Patent Application Publication
(10) Pub. No.: US 2014/0374325 A1
(43) Pub. Date: Dec. 25, 2014

(54) Magnetic Separator and Method

(71) Applicant: Lothar Jung, Bridgewater, NJ (US)

(72) Inventor: Lothar Jung, Bridgewater, NJ (US)

(21) Appl. No.: 13/924,702

(22) Filed: Jun. 24, 2013

(51) Int. Cl. B03C 1/025

(52) U.S. Cl. CPC B03C 1/025
USPC 209/212

(57) ABSTRACT

A system and method for magnetically separating diamagnetic and paramagnetic particulate material from a dry admixture comprises a rectangular block ramp formed of multiple rectangular block magnetic elements laterally alternating with multiple rectangular soft-magnetic spacer strips. The magnetic elements are arranged in “bucking mode,” with identical poles facing each other on either side of the spacer strips. The ramp is supported at an adjustable angular inclination by a hinged mounting bracket. Two sets of product receptacles are horizontally and laterally positioned to separately collect falling bands of diamagnetic and paramagnetic material.

### BACKGROUND OF THE INVENTION

The present invention relates to devices and methods for separating feebly magnetic granular materials, which may be either paramagnetic or diamagnetic in nature, for the purpose of isolating specific material from a heterogeneous batch.

In various applications, it is necessary to isolate a specific granular component from a mixed or impure feedstock based its magnetic properties. The magnetism of minerals ranges from ferromagnetic (e.g., iron) to paramagnetic (e.g., aluminum) to diamagnetic (e.g., graphite). In the production of very high-purity quartz (SiO₂) for semi-conductors, for example, it's necessary to separate the diamagnetic SiO₂ component from paramagnetic mineral impurities. It has been demonstrated that, for the best separation of paramagnetic and diamagnetic materials, a high intensity magnetic field with high field gradients is required.

U.S. Pat. No. 4,882,043 to Jung (hereinafter referred to as “Jung '043”), which is incorporated herein by reference, teaches a roll-type magnetic separator. As depicted in FIG. 1 of the Jung '043 disclosure, the magnetic roll comprises a plurality of disc-shaped magnetic elements (12) and a plurality of disc-shaped soft-magnetic (i.e., having high magnetic permeability) spacer elements (14), arranged in an alternating, axially aligned series on a horizontal shaft (18). The magnetic elements (12) are arranged in “bucking mode,” i.e., with identical poles—north or south—facing each other on either side of the spacer elements.

The “bucking mode” assembly is illustrated in FIG. 1A hereto, wherein the magnetic elements 101 are separated by soft-magnetic spacer elements 102. As shown in FIG. 1B hereto, in the “bucking mode,” the magnetic energy intensity and magnetic field gradient are highest across the spacer elements 102 and lowest in the middle of the magnetic elements 101. Consequently, as depicted in FIG. 1A, the paramagnetic materials 103 are drawn toward the soft-magnetic strip interface 102, while the diamagnetic products 104 are pushed toward the center of the magnetic element 101 and away from contact with, the magnet surface. Therefore, the “bucking mode” assembly of magnetic elements 101 and soft-magnetic spacer elements 102, as shown in FIG. 1A, results in a lateral separation of paramagnetic 103 and diamagnetic 104 materials in alternating bands.

In the roll-type separator described in Jung '043, a drive motor rotates the roll, such that the bands of diamagnetic material will spin. off the roll surface along a tangent thereto, while the paramagnetic material will cling to the roll longer (as shown in FIG. 2 of Jung '043) thereby allowing the two types of material to be separately collected.

FIG. 2 hereto depicts as exemplary roll-type magnetic separator, having a roll 201 with radius R, comprising disks 202 of alternating magnetic 101 and spacer 102 elements (as depicted in FIG. 1A), assembled on a shaft 203, driven by a motor at a selected RPM, based on the feed rate of the heterogeneous material 204. In this example, a belt 209 is used to carry the material 204 to the roll 201. The diamagnetic material 204 separates from the roll 201 along a tangent thereto, while the paramagnetic 206 and ferromagnetic 207 components remain magnetically attached to the roll 201 until the combination of gravitational and centrifugal forces causes them to detach and fail. A series of splitters 208 in horizontally spaced relationship are used to separately collect the material components.

Table 1 in the upper right of FIG. 2 indicates the percentage of the magnetic disks 202 used at any time as a function of the rotation of the roll 201. These data reflects under-utilization of the disks 202 and inefficient use of their magnetic energy. This magnetic utilization inefficiency is compounded by the energy expended in rotating the roll 201.

The present invention addresses these inefficiencies by replacing the rotating roll 201 with one or more stationary inclined magnetic blocks, By making better use of gravitational forces to separate the heterogeneous materials 204, the present invention eliminates the need to generate centrifugal forces through the rotation of a roll 201. This design thereby enables much greater utilization of the system's magnetic energy, while also saving the energy of the motor drive needed to rotate a roll 201.

### SUMMARY OF THE INVENTION

In the present invention, the magnet arrangement is in the form of a magnetic block, wherein the magnets are composed of rectangular elements of high strength permanent magnets and soft-magnetic strips rather than disks. The magnetic parts are glued together with a high strength glue.

In order to accommodate production rates, the magnets are packaged in blocks, which may be optimized for any particular product. The blocks are mounted on holders that are inclined to receive the product by gravitational feed under adjustable angles to control residence time. The magnet block is mounted on a holder that may be constructed of a weekly magnetic stainless steel. A plurality of splitters in a horizontal spaced relationship are used to separate the different trajectories of diamagnetic and paramagnetic materials.

The magnet system may be equipped with another permanent magnet at the feeder side that eliminates ferromagnetic particles as they would stick and render useless the magnet blocks. As the granular products slides down the magnetic surfaces fed by gravity, the diamagnetic product is laterally separated from the paramagnetic product and is also pushed into different trajectories so that they can be collected in different compartments.

A further advantage of this arrangement is to be able to reduce the layer thickness of the product feed to approach a monolayer and prevent masking of grains that would result in multiple submissions to the magnets.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1A is schematic depiction of the “bucking mode” assembly of magnetic elements and soft-magnetic spacers in a magnetic separation roll;

FIG. 1B is a graph representing the distribution of magnetic energy density across the magnetic assembly depicted in FIG. 1A;

FIG. 2 is a schematic depiction of an exemplary roll-type magnetic separator;

FIG. 3A is a perspective view of a magnetic block ramp according to the preferred embodiment of the present invention;

FIG. 3B is a side view of a magnetic block ramp according to the preferred embodiment of the present invention;

FIG. 4A is a side partial cutaway view of a magnetic separator according to the preferred embodiment of the present invention;

FIG. 4B is a front partial cutaway view of a magnetic separator according to the preferred embodiment of the present invention;

FIG. 5 is front view of a linear array of magnetic separator units; and

FIG. 6 is a perspective view of a circular arrangement of magnetic separator units.

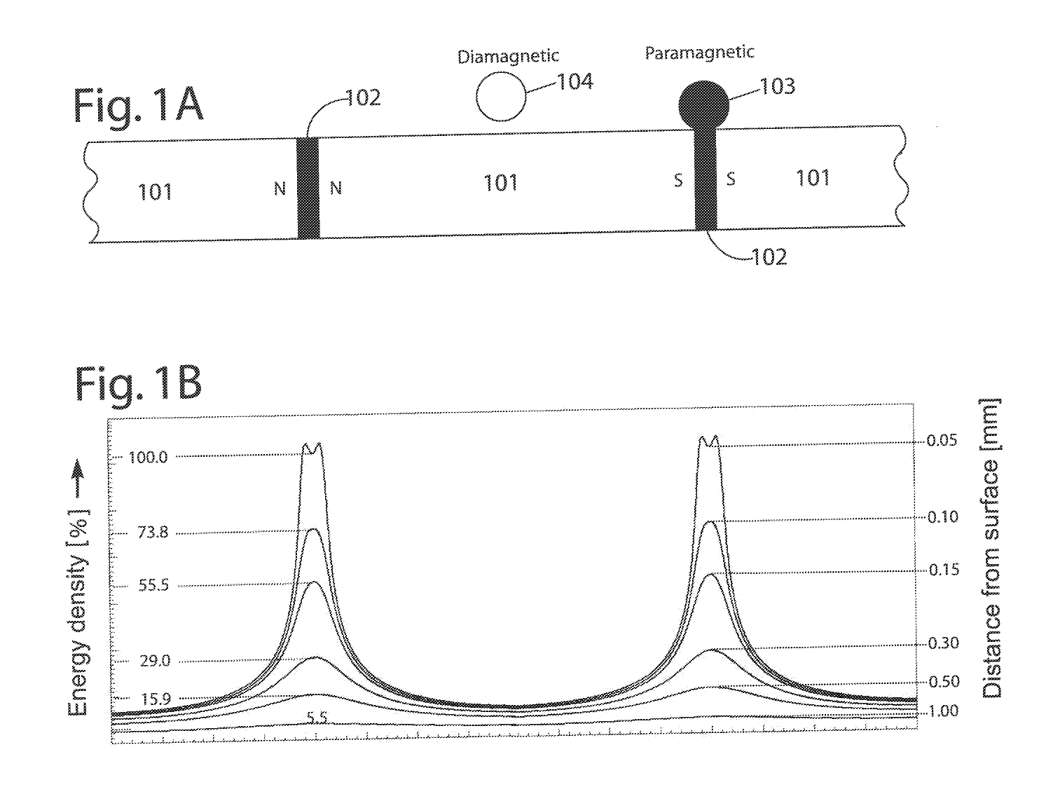

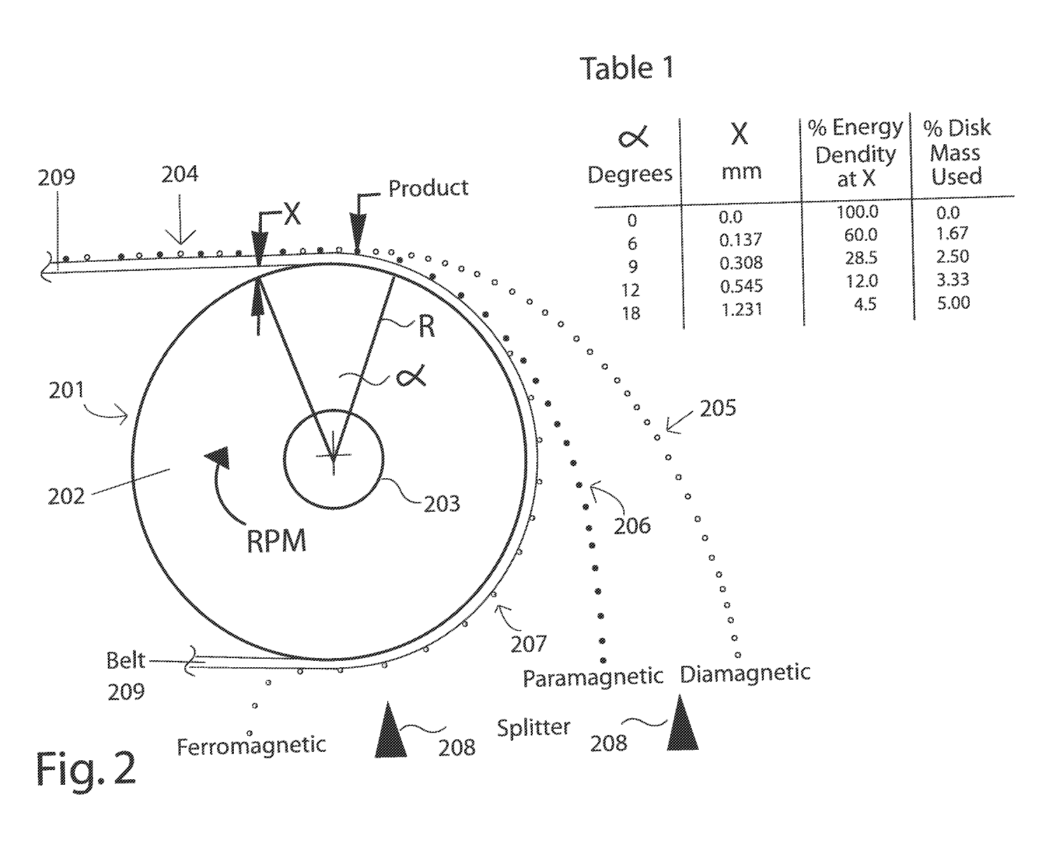

### DETAILED DESCRIPTION OF THE PREFERRED EMBODIMENT

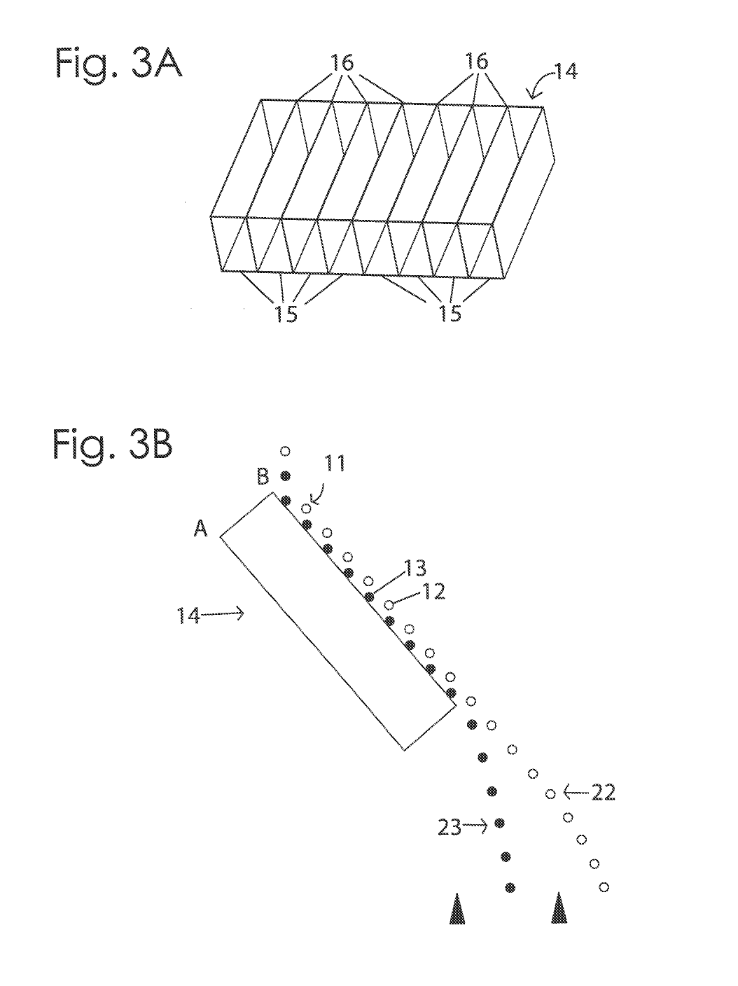

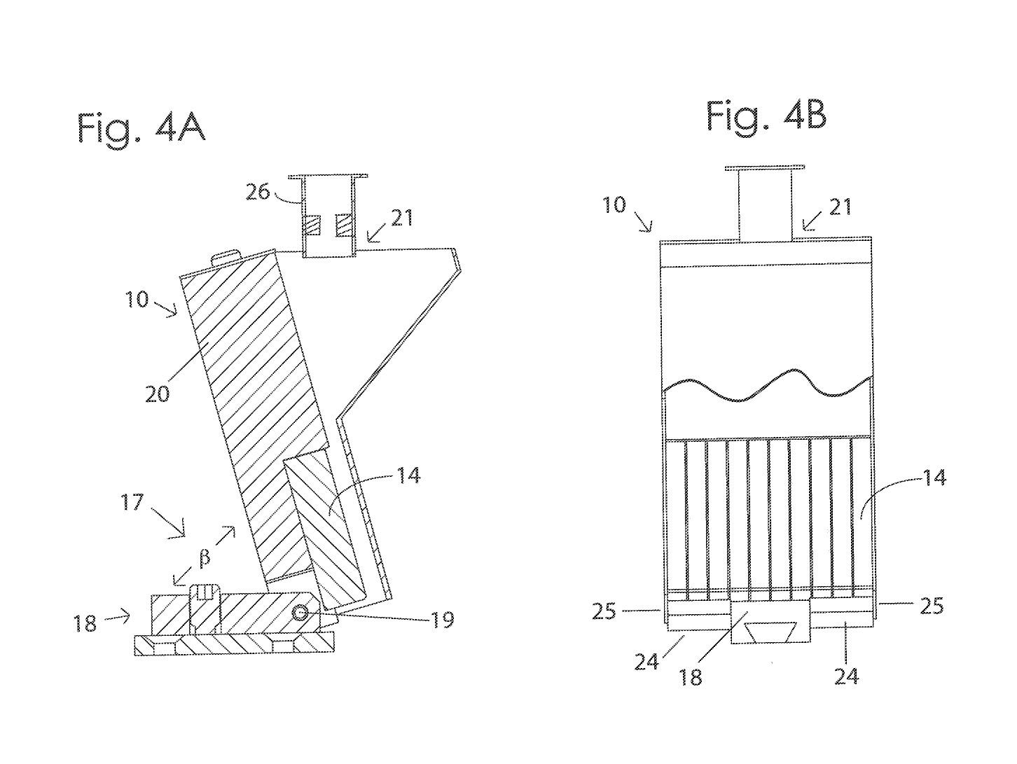

As shown in FIGS. 3A-B and FIGS. 4A-4B, a magnetic separation apparatus 10 for separating a dry admixture 11 containing particulate diamagnetic 12 and paramagnetic 13 material comprises a rectangular block ramp 14 formed of a plurality of rectangular block magnetic elements 15 and a plurality of rectangular soft-magnetic spacer strips 16. The magnetic elements 15 and the spacer strips 16 are arranged in an alternating, abutting, laterally-aligned series. Each of the magnetic elements 15 has a north magnetic pole and a south magnetic pole, and each of the magnetic elements 15 on either side of one of the spacer strips 16 has the same magnetic pole facing the spacer strip 16.

The magnetic separator 10 further comprises a hinged mounting bracket 17, comprising a horizontal base 18 rotably connected by a hinge mechanism 19 to a ramp holder 20. The ramp 14 is supported by the ramp holder 20 at an adjustable angular inclination 13 with respect to the base 18.

The magnetic separator 10 further comprises a material feeder 21 that distributes the admixture 11 by gravity onto the top of the ramp 14 substantially uniformly across the width of the ramp 14. The admixture 11 separates laterally across the ramp 14 to form bands of paramagnetic material 13, along the spacer strips 16, alternating with bands of diamagnetic material 12, along the magnetic elements 15. The bands of paramagnetic 13 and diamagnetic 12 material slide down the ramp 14 and fall from the bottom of the ramp 14 at different trajectories, such that the trajectory of the diamagnetic material 22 has a greater horizontal component than the trajectory of the paramagnetic material 23.

The magnetic separator 10 further comprises one or more first product receptacles 24, such that each first product receptacle 24 is horizontally and laterally positioned to receive one or more of the falling bands of diamagnetic material 22. The separator 10 also comprises one or more second product receptacles 25, such that each second product receptacle 25 is horizontally and laterally positioned to receive one or more of the falling bands of paramagnetic material 13.

The separator also comprises a magnetic filter 26 in the material feeder 21. The magnetic filter 26 removes ferromagnetic material from the admixture 11 so that no ferromagnetic material reaches the ramp 14.

The apparatus is used for separating a diamagnetic material 12 from a dry admixture 11 by adjusting the angular inclination 13 of the base 18 to accommodate a required feed rate of the admixture 11 and feeding the admixture 11 by gravity at the required feed rate onto the top of the ramp 14 substantially uniformly across the width of the ramp 14, so that the admixture 11 separates laterally across the ramp 14 to form bands of paramagnetic material 13, along the spacer strips 16, alternating with bands of diamagnetic material 12, along the magnetic elements 16. The hands of paramagnetic and diamagnetic material slide down the ramp 14 and fall from the bottom of the ramp 14 at different trajectories, such that the trajectory of the diamagnetic material 22 has a greater horizontal component than the trajectory of the paramagnetic material 23. The falling bands of diamagnetic material 22 are collected in one or more first product receptacles 24, each of which is horizontally and laterally positioned to receive one or more of the falling bands of diamagnetic material 22. The falling bands of paramagnetic material 23 are separately collected in one or more second product receptacles 25, each of which is horizontally and laterally positioned to receive one or more of the falling bands of paramagnetic material 23.

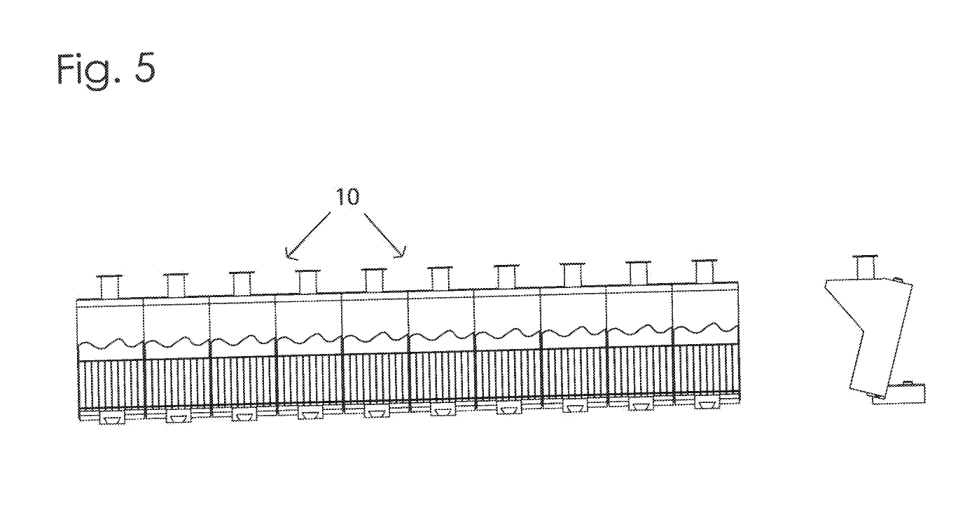

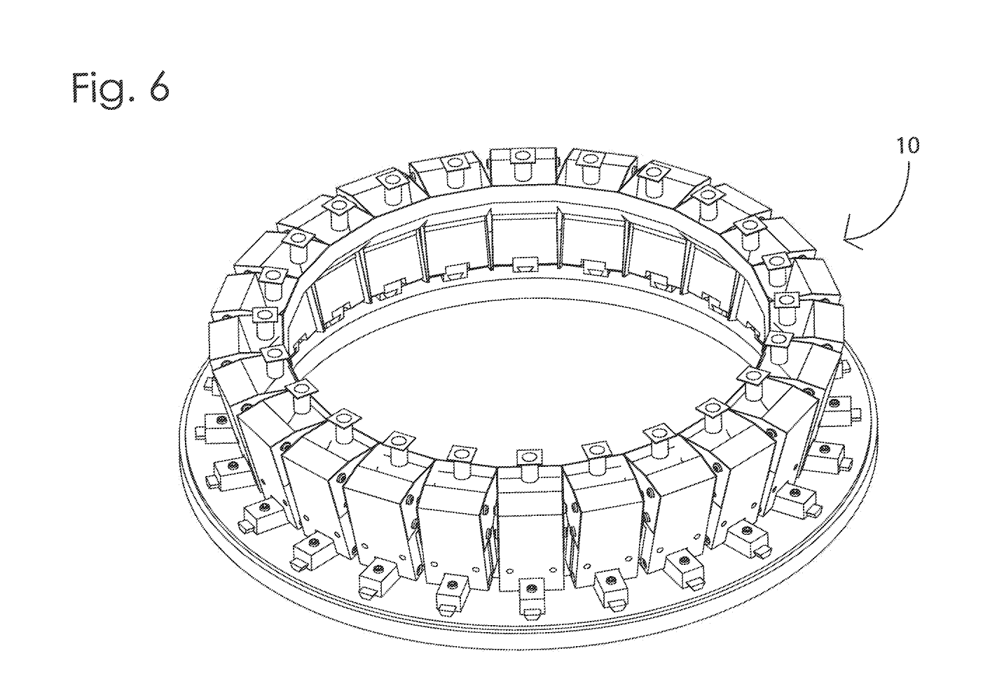

Optionally, multiple separators 10 can be arranged in linear arrays, as depicted in FIG. 5, in order to accommodate different hourly production rates. Alternately, multiple separators 10 can be arranged in a circular array, as shown in FIG. 6, to achieve higher throughput in a compact area.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. A magnetic separation apparatus for separating a dry admixture comprising particulate diamagnetic and paramagnetic material, the apparatus comprising;
(a) a rectangular block ramp formed of a plurality of rectangular block magnetic elements and a plurality of rectangular soft-magnetic spacer strips, wherein each of the magnetic elements and the spacer strips has a length and has a width that is shorter than the length, and wherein the length of each magnetic element and each spacer strip is longitudinally oriented with respect to the ramp, and wherein the magnetic elements and the spacer strips are arranged in an alternating, abutting, laterally-aligned series, and wherein each of the magnetic elements has a north magnetic pole and a south magnetic pole, and wherein each of the magnetic elements on either side of one of the spacer strips has the same magnetic pole facing the spacer strip;
(b) a hinged mounting bracket, comprising a horizontal base rotably connected by a hinge mechanism to a ramp holder, wherein the ramp is supported by the ramp holder at an adjustable angular inclination with respect to the base;
(c) a material feeder that distributes the admixture by gravity onto the top of the ramp substantially uniformly across the width of the ramp, whereby the admixture separates laterally across the ramp to form bands of paramagnetic material, along the spacer strips, alternating with bands of diamagnetic material, along the magnetic elements, and whereby the bands of paramagnetic and diamagnetic material slide down the ramp and fall from the bottom of the ramp at different trajectories, such that the trajectory of the diamagnetic material has a greater horizontal component than the trajectory of the paramagnetic material;
(d) one or more first product receptacles, wherein each first product receptacle is horizontally and laterally positioned to receive one or more of the falling bands of diamagnetic material; and
(e) one or more second product receptacles, wherein each second product receptacle is horizontally and laterally positioned to receive one or more of the falling bands of paramagnetic material.

2. The apparatus of claim 1, further comprising a magnetic filter in the material feeder, wherein the magnetic filter removes ferromagnetic material from the admixture so that no ferromagnetic material reaches the ramp.

3. A method for separating a diamagnetic material from a dry admixture comprising particulate diamagnetic and paramagnetic material, the method comprising:
(a) providing a rectangular block ramp formed of a plurality of rectangular block magnetic elements and a plurality of rectangular soft-magnetic spacer strips, wherein the magnetic elements and the spacer strips are arranged in an alternating, abutting, laterally-aligned series, and wherein each of the magnetic elements has a north magnetic pole and a south magnetic pole, and wherein each of the magnetic elements on either side of one of the spacer strips has the same magnetic pole facing the spacer strip;
(b) providing a hinged mounting bracket, comprising a horizontal base rotably connected by a hinge mechanism to a ramp holder, wherein the ramp is supported by the ramp holder at an adjustable angular inclination with respect to the base;
(c) adjusting the angular inclination of the base to accommodate a required feed rate of the admixture;
(d) feeding the admixture by gravity at the required feed rate onto the top of the ramp substantially uniformly across the width of the ramp, so that the admixture separates laterally across the ramp to form bands of paramagnetic material, along the spacer strips, alternating with bands of diamagnetic material, along the magnetic elements;
(e) allowing the bands of paramagnetic and diamagnetic material to slide down the ramp and fall from the bottom of the ramp at different trajectories, such that the trajectory of the diamagnetic material has a greater horizontal component than the trajectory of the paramagnetic material;
(f) separately collecting the falling hands of diamagnetic material in one or more first product receptacles, each of which is horizontally and laterally positioned to receive one or more of the falling bands of diamagnetic material; and
(g) separately collecting the falling bands of paramagnetic material in one or more second product receptacles, each of which is horizontally and laterally positioned to receive one or more of the failing bands of paramagnetic material.

4. The method of claim 3, comprising the additional step of magnetically removing ferromagnetic material from the admixture before feeding the admixture onto the top of the ramp.
